(19) United States
(12) Patent Application Publication
(10) Pub. No.: US 2010/0126615 A1
(43) Pub. Date: May 27, 2010

(54) FLEXIBLE EXTENSION DEVICE FOR FAUCET STEM

(76) Inventor: Donald W. Jacobsmeyer, St. Louis, MO (US)

Correspondence Address: Polster, Lieder, Woodruff & Lucchesi, L.C., 12412 Powerscourt Dr. Suite 200, St. Louis, MO, 63131-3615, US

(21) Appl. No.: 12/323,012

(22) Filed: Nov. 25, 2008

(51) Int. Cl. F16L 11/00

(52) U.S. Cl. 137/801; 138/118

(57) ABSTRACT

A flexible extension device (10) for remotely operating a faucet (F). The faucet's handle (H) is removed for one end (12) of the device to be coupled to the faucet's stem (M). The handle is then attached to the other end (16) of the device. The device has a length sufficient so that when installed, the handle is readily accessible to the faucet's user. Because the extension device is flexible, it can be appropriately bent or twisted so the handle is now conveniently located for the user. The device, when installed, allows ready access for the user so they can remotely operate the faucet to open and shut it, and regulate the flow of water from the faucet.

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

This invention relates to water faucets such as those to which outdoor hoses are attached; and, more particularly, to a flexible extension device attachable to the faucet stem which allows a faucet located in a generally inaccessible area to be readily turned open and shut.

It is not uncommon for an outdoor faucet such as one to which a hose is attached for watering the yard, washing a car, etc., to be located behind a shrub or bush so that the user cannot readily reach the faucet to turn it in one direction to open it and in the opposite direction to shut it. Typically, a shrub or bush that was planted to one side of the faucet's location has, over time, grown up and now hides the faucet preventing easy access. Sometimes the faucet is hidden behind a rose or other thorny bush so the person operating the faucet runs a good risk of getting stuck.

In another situation, faucets are often located in a basement or a utility room near laundry equipment. While these faucets are usually much more accessible, handicapped people, people with limited mobility, people with arthritis or other medical conditions may find it difficult to either reach the handles on the faucets or have sufficient strength to open and shut them.

While relocating a faucet for easier access is a possibility, doing so can be both time consuming and expensive. Rather, for either of the above described situations, it would be much simpler and more helpful to provide a mechanism that is easily installed yet provides ready access to a faucet so a user can readily operate the faucet, do so easily, and not risk injury.

### BRIEF SUMMARY OF THE INVENTION

The present disclosure is directed to a flexible extension device for a faucet. The faucet's handle is removed for one end of a flexible section of the device to be coupled to the faucet's stem. The handle is then attached to the other end of the section. The section has a length sufficient so that when installed, the handle is readily accessible to the faucet's user. Because the section is flexible, it can be bent or twisted, as appropriate, so the handle is now conveniently located for the user. When installed, the section provides ready access for the user so he or she can operate the valve to open and shut the faucet as well as regulate the flow of water from the faucet.

With the extension installed, the faucet is remotely operated. The flexible section of the device comes is a variety of lengths. The device also comes in kit form with a separate handle from that installed on the faucet, and a bracket which fits over the extension and is attachable to a support to hold the handle end of the extension in a desired location for easy access and operability by the user.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a simplified representation of an outdoor water faucet to which a hose is attached;

FIG. 2 is a representation similar to FIG. 1, but with the flexible extension of the present invention installed on the faucet;

FIG. 3 is a simplified representation of a faucet installed by a sink;

FIG. 4 is a representation similar to FIG. 3, but with the flexible extension installed on the faucet to make it more accessible for one unable to otherwise operate the faucet; and,

FIG. 5 is a cross-sectional view of the flexible extension.

Corresponding reference characters indicate corresponding parts throughout the several views of the drawings.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

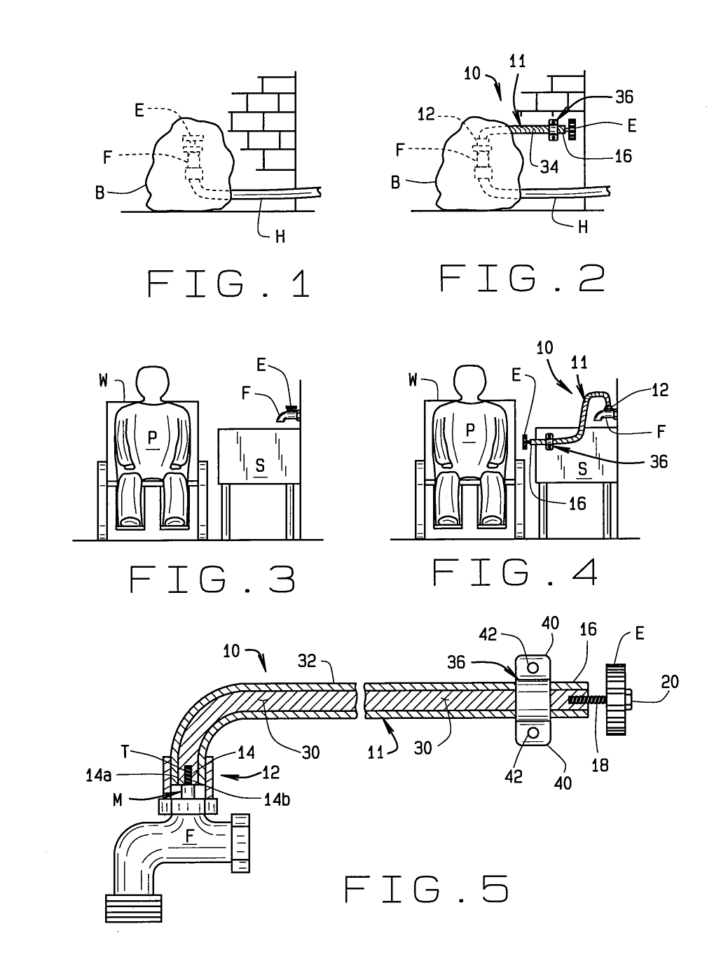

Referring to the drawings, a water faucet F is found in bathrooms where they deliver cold and hot water to a sink S or bathtub (not shown), and in kitchens where they deliver water to a sink. Faucets are also often found in the laundry room or area inside a house where laundry is done so to supply to water to a washing machine (not shown) as well as a sink if one is located there. A faucet is also located on the outside of a house or on an outbuilding (garage). With respect to these latter faucets, a hose H is usually connected to the faucet for use in watering the lawn, washing cars, etc. As shown in FIG. 1, it is not uncommon for shrubbery B to be planted adjacent the spot outside the house where a faucet is located. Over time, and as shown in FIG. 1, the shrubbery may well grow up and about the faucet making it hard to reach. If the shrubbery has thorns, such as a rosebush, someone trying to reach the faucet handle E, to open the faucet or turn it off, might well get scratched or cut.

Referring to FIG. 2, one difficulty with both outside and inside faucets is that they are not always readily accessible to, for example, a wheelchair W bound or otherwise handicapped person P. Accordingly, it is difficult for these people to turn on the water in order to take a bath, wash their hands, clean dishes, soak clothes, etc. Oftentimes, it may be that the faucet is simply inconveniently located for someone wanting to use it, and it would be helpful if there was a way to make the faucet easier to reach and use.

In accordance with the present invention, a flexible extension device 10 is used to relocate handle E of faucet F a distance away from the faucet and in a location that makes it easier for a user to open and shut the faucet and regulate flow of water through the faucet. Thus, as shown in FIG. 2, handle E of the faucet is now located away from the shrubbery so someone wanting to turn hose H on and off can do so without risk of injury from the shrub. As shown in FIG. 4, device 10 allows handle E of the faucet to be placed at the front of the sink where it is more readily accessible to one wanting to operate the faucet.

Flexible extension device 10 includes a flexible section 11 with a connector or coupling 12 attached to one end. This coupling is at an end of the extension which connects to the faucet's stem M when the handle E normally attached to the stem is removed. That is, stem E extends through an opening at the top of the faucet. The outer end of the stem is threaded, as indicated T in FIG. 5. Handle E fits over this threaded end of the stem and is attached to the stem using a nut (not shown). Or, the outer end of the stem has a threaded, inwardly extending bore (not shown). The handle fits over this portion of the stem and is secured to the stem by a bolt (not shown) which fits through a central opening (also not shown) in the handle and is screwed into the bore. Coupling 12 includes a sleeve 14 whose inner surface 14f is configured to mate with the outer contour of stem M once handle E is removed. This allows rotation of the sleeve in either direction to produce a corresponding rotation of the stem.

The device next includes a connector or coupling 16 which is located at the other end of section 11. Coupling 16 includes, for example, a fitting 18 whose outer end extends beyond the end of the coupling. This outer end of the fitting is threaded to receive a handle E. This handle can be the same handle that is removed from stem M of faucet F, or another handle which may be part of a kit used with device 10 for installing and using the extension. Once the handle is installed on fitting 18, a nut 20 is threaded onto the outer end of the extension to secure the handle in place.

Section 11 of device 10 comprises a flexible shaft 30 extending the length of the extension between the respective couplings. The shaft transmits the force produced by someone turning the handle E connected to coupling 16 to the stem M connected to coupling 12. Turning handle E in one direction rotates stem M in the direction to open faucet F; while, turning the handle in the opposite direction rotates the stem in the direction to shut the faucet. It is an important feature of the invention that shaft 30 is sufficiently flexible that in can be bent and rotated, as shown in FIGS. 2, 4, and 5, so that handle E can be conveniently located for a user to remotely operate faucet F via the flexible extension. Shaft is enclosed throughout its length by a sheath 32. This sheath can be a metal sheath or the sheath can be made of a plastic or rubber material. Regardless of the material from which it is made, the sheath protects shaft 30 from damage so the operability of flexible extension 10 is not impaired. Further, as shown in FIG. 2, the sheath may be formed by a plurality of overlapping segments 34.

Once flexible extension 10 is connected to stem M of faucet F, and the other end of the extension is located at a convenient location for a user to remotely operate the faucet, a bracket 36 is used to secure this end of the extension in place. Bracket 36 has a semi-circular center section 38 which fits about shaft 30 and tabs 40 on opposite sides of section 38 for the bracket to be affixed to the side of the house or outbuilding, or a sink, using an appropriate fastener 42. The bracket is mounted such that it is adjacent the inner end of coupling 16, so that while the extension is bent and rotated as necessary to locate handle E in an accessible location, when the user goes to manipulate the handle, it stays rather firmly in place. This allows the user to need only one hand to operate the handle rather than having to hold the end of the extension with one hand and turn the handle with the other hand.

Those skilled in the art will understand that while the components comprising flexible extension 10 could be purchased separately, as a practical matter, the device is packaged and sold as a kit. The kit includes one or more flexible extension sections 11. For example, for use indoors, the kit would come with two sections of the same length, one for a cold water faucet, and the other for a hot water faucet. Different kits would also have sections of different lengths so a person could select an appropriate length for their particular situation. Next the kit would include a handle E and nut N for attaching the handle to the one end of section 11. Finally, the kit includes a bracket 36 and a pair of fasteners 42 for fixing the bracket in place once the flexible extension has been installed and the handle properly located for a user to remotely open and shut faucet F and regulate the flow of water through the faucet.

In view of the above, it will be seen that the several objects and advantages of the present disclosure have been achieved and other advantageous results have been obtained.

Having thus described the invention, what is claimed and desired to be secured by Letters Patent is:

1. A flexible extension device for a faucet comprising:
an elongate flexible section having a first coupling at one end thereof which connects to the faucet's stem when the handle normally attached to the stem is removed, and a second coupling at the other end thereof to which a handle for turning the stem to open and close the faucet is connected; and,
the section including a flexible shaft extending from the first coupling to the second coupling to transmit a force produced by turning the handle connected to the second coupling to the stem connected to the first coupling whereby turning the handle in one direction rotates the stem in a direction to open the faucet and turning the handle in the opposite direction rotates the stem in a direction to close the faucet thereby for the faucet to be remotely operated.

2. The device of claim 1 further including a sheath extending the length of the section and covering the shaft to protect the shaft from damage.

3. The device of claim 1 in which the shaft can be bent and twisted as appropriate to position the faucet handle in a location remote from the faucet and accessible by a user to open the faucet and shut it off.

4. The device of claim 1 further including a bracket for securing the end of the section adjacent the second coupling so to position the handle in a desired location.

5. The device of claim 2 in which the sheath is a metal sheath.

6. The device of claim 2 in which the sheath is a rubber or plastic sheath.

7. The device of claim 1 in which the first coupling includes a sleeve whose inner surface is configured to mate with an outer contour of the stem once the handle is removed from the stem whereby rotation of the sleeve in either direction produces a corresponding rotation of the stem.

8. The device of claim 7 in which the second coupling includes a fitting whose outer end extends beyond the end of the second coupling for the handle to be received on an outer end of the fitting.

9. The device of claim 8 in which the outer end of the fitting is threaded for a nut to be threaded onto the fitting, after the handle is installed, to secure the handle to the extension.

10. The device of claim 1 further including a bracket for securing the end of the section to which the handle is connected in place to facilitate turning of the handle by a user.

11. The device of claim 2 in which the sheath is formed of a plurality of overlapping segments.

12. A kit for use with a faucet to locate a handle for the faucet remotely therefrom comprising:
an elongate flexible section having coupling at each end thereof with one of the couplings connecting to the faucet's stem when the handle normally attached to the stem is removed, and a handle for turning the stem to open and close the faucet being connected to the coupling at the other end of the section; and,
a bracket for securing the end of the section to which the handle is connected in place to facilitate operation of the handle by a user.

13. The kit of claim 12 in which the elongate flexible section includes a flexible shaft extending from the one coupling to the other coupling to transmit a force produced by turning the handle connected to the other coupling to the stem connected to the first said coupling whereby turning the handle in one direction rotates the stem in a direction to open the faucet and turning the handle in the opposite direction rotates the stem in a direction to close the faucet thereby for the faucet to be remotely operated.

14. The kit of claim 13 in which the shaft can be bent and twisted as appropriate to position the faucet handle in a location remote from the faucet and accessible by a user to open the faucet and shut it off.

15. The kit of claim 14 further including a sheath extending the length of the section and covering the shaft to protect the shaft from damage, the sheath being of a metal, plastic, or rubber material.

16. The kit of claim 15 in which the sheath is formed of a plurality of overlapping segments.

17. The kit of claim 12 in which the first said coupling includes a sleeve whose inner surface is configured to mate with an outer contour of the stem once the handle is removed from the stem whereby rotation of the sleeve in either direction produces a corresponding rotation of the stem.

18. The kit of claim 17 in which the other coupling includes a fitting whose outer end extends beyond the end of the second coupling for the handle to be received on an outer end of the fitting.

19. The kit of claim 18 in which the outer end of the fitting is threaded for a nut to be threaded onto the fitting, after the handle is installed, to secure the handle to the extension.
